(19) United States
(12) Patent Application Publication
(10) Pub. No.: US 2026/0369631 A1
(43) Pub. Date: Nov. 19, 2026

(54) ELECTROCHEMICAL CELL, ELECTROCHEMICAL CELL DEVICE, MODULE, AND MODULE HOUSING DEVICE

(71) Applicant: KYOCERA Corporation, Kyoto-shi, Kyoto (JP)

(72) Inventors: Yuuichi HORI, Kirishima-shi, Kagoshima (JP); Kazunari MIYAZAKI, Kirishima-shi, Kagoshima (JP)

(21) Appl. No.: 19/142,883

(22) PCT Filed: Dec. 26, 2023
(86) PCT No.: PCT/JP2023/046645

§ 371 Date: Jun. 24, 2025

(30) Foreign Application Priority Data
Dec. 26, 2022 (JP) 2022-209058

(51) Int. Cl. H01M 8/0215; H01M 4/86

(52) U.S. Cl. CPC H01M 8/0215; H01M 4/8673

(57) ABSTRACT

An electrochemical cell includes a first electrode, a first electrically conductive member, and a second electrically conductive member. The first electrode contains a first material having ion conductivity and in which a first element is in a solid solution and a second material having electron conductivity. A first element is in a solid solution in the first material. The first electrically conductive member contains a second element different from the first element and the second material. The second electrically conductive member is located between the first electrode and the first electrically conductive member and contains the first element, the second element, and the second material. The first element is one or more elements selected from the group consisting of Mg, Ca, and rare earth elements. The second element is one or more of elements selected from the group consisting of Mg, Ca, Ti, Si, Al, Si, and rare earth elements.

### TECHNICAL FIELD

The present disclosure relates to an electrochemical cell, an electrochemical cell device, a module, and a module housing device.

### BACKGROUND OF INVENTION

In recent years, various fuel cell stack devices each including a plurality of fuel cells have been proposed as next-generation energy. A fuel cell is a type of electrochemical cell capable of obtaining electrical power by using a fuel gas such as a hydrogen-containing gas and an oxygen-containing gas such as air.

### CITATION LIST

### Patent Literature

Patent Document 1: JP 2014-524655 T

### SUMMARY

An electrochemical cell according to an aspect of an embodiment includes a first electrode, a first electrically conductive member, and a second electrically conductive member. The first electrode contains a first material having ion conductivity and a second material having electron conductivity. A first element is in a solid solution in the first material. The first electrically conductive member contains a second element different from the first element and the second material. The second electrically conductive member is located between the first electrode and the first electrically conductive member and contains the first element, the second element, and the second material. The first element is one or more elements selected from the group consisting of Mg, Ca, and rare earth elements. The second element is one or more of elements selected from the group consisting of Mg, Ca, Ti, Si, Al, Si, and rare earth elements.

An electrochemical cell device of the present disclosure includes a cell stack including the electrochemical cell described above.

A module of the present disclosure includes the electrochemical cell device described above and a storage container housing the electrochemical cell device.

Further, a module housing device of the present disclosure includes the module described above, an auxiliary device for operating the module, and an external case housing the module and the auxiliary device.

### BRIEF DESCRIPTION OF THE DRAWINGS

FIG. 1A is a horizontal cross-sectional view illustrating an example of an electrochemical cell according to a first embodiment.

FIG. 1B is a side view of an example of the electrochemical cell according to the first embodiment when viewed from the side of an air electrode.

FIG. 1C is a side view of an example of the electrochemical cell according to the first embodiment when viewed from the side of an interconnector.

FIG. 2A is a perspective view illustrating an example of an electrochemical cell device according to the first embodiment.

FIG. 2B is a cross-sectional view taken along a line X-X illustrated in FIG. 2A.

FIG. 2C is a top view illustrating an example of the electrochemical cell device according to the first embodiment.

FIG. 3 is an enlarged cross-sectional view of a region R1 indicated in FIG. 1A.

FIG. 4 is an exterior perspective view illustrating an example of a module according to the first embodiment.

FIG. 5 is an exploded perspective view schematically illustrating an example of a module housing device according to the first embodiment.

FIG. 6 is a cross-sectional view illustrating an electrochemical cell device according to a second embodiment.

FIG. 7 is a horizontal cross-sectional view illustrating an example of an electrochemical cell according to the second embodiment.

FIG. 8 is an enlarged cross-sectional view of a region R2 indicated in FIG. 7.

FIG. 9A is a horizontal cross-sectional view illustrating an example of the electrochemical cell according to a third embodiment.

FIG. 9B is a horizontal cross-sectional view illustrating another example of the electrochemical cell according to the third embodiment.

FIG. 9C is a horizontal cross-sectional view illustrating another example of the electrochemical cell according to the third embodiment.

FIG. 10 is an enlarged cross-sectional view of a region R3 indicated in FIG. 9A.

### DESCRIPTION OF EMBODIMENTS

The fuel cell stack device mentioned above has room for improvement in terms of durability.

Provision of an electrochemical cell, an electrochemical cell device, a module, and a module housing device that can improve durability is expected.

Embodiments of an electrochemical cell, an electrochemical cell device, a module, and a module housing device disclosed in the present application will now be described in detail with reference to the accompanying drawings. Note that the disclosure is not limited by the following embodiments.

Note that the drawings are schematic and that the dimensional relationships between elements, the proportions of the elements, and the like may differ from the actual ones. There may be differences between the drawings in the dimensional relationships, proportions, and the like.

### First Embodiment

### Configuration of Electrochemical Cell

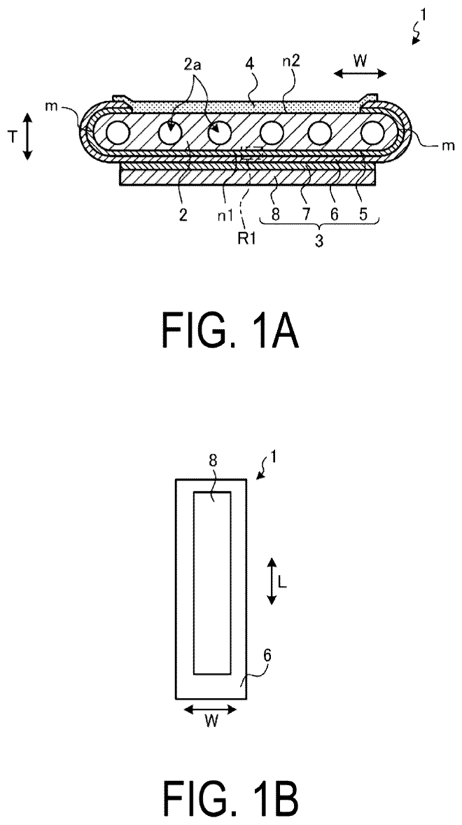

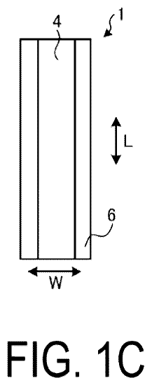

First, with reference to FIGS. 1A to 1C, an example of a solid oxide fuel cell will be described as an electrochemical cell constituting the electrochemical cell device according to the first embodiment. The electrochemical cell device may include a cell stack including a plurality of electrochemical cells. The electrochemical cell device including the plurality of electrochemical cells is simply referred to as a cell stack device.

FIG. 1A is a horizontal cross-sectional view illustrating an example of an electrochemical cell according to a first embodiment. FIG. 1B is a side view of an example of the electrochemical cell according to the first embodiment when viewed from the side of an air electrode. FIG. 1C is a side view of an example of the electrochemical cell according to the first embodiment when viewed from the side of an interconnector. Note that FIGS. 1A to 1C are enlarged views each illustrating part of a configuration of the electrochemical cell. Hereinafter, the electrochemical cell may be simply referred to as a cell.

In the example illustrated in FIGS. 1A to 1C, a cell 1 is of a hollow flat plate type, and has an elongated plate shape. As illustrated in FIG. 1B, the overall shape of the cell 1 when viewed from the side is, for example, a rectangle having a side length of from 5 cm to 50 cm in a length direction L and a length of from 1 cm to 10 cm in a width direction W orthogonal to the length direction L. The thickness in a thickness direction T of the entire cell 1 is, for example, from 1 mm to 5 mm.

As illustrated in FIG. 1A, the cell 1 includes a support substrate 2 with electrical conductivity, an element portion 3, and an interconnector 4. The support substrate 2 has a pillar shape having a pair of a first surface n1 and a second surface n2 that face each other, and a pair of arc-shaped side surfaces m that connect the first surface n1 and the second surface n2.

The element portion 3 is provided on the first surface n1 of the support substrate 2. The element portion 3 includes a fuel electrode 5, a solid electrolyte layer 6, and an air electrode 8. In the example illustrated in FIG. 1A, the interconnector 4 is located on the second surface n2 of the cell 1. Note that the cell 1 may include an intermediate layer 7 between the solid electrolyte layer 6 and the air electrode 8.

As illustrated in FIG. 1B, the air electrode 8 does not extend to the lower end of the cell 1. At the lower end portion of the cell 1, only the solid electrolyte layer 6 is exposed on a surface of the first surface n1. As illustrated in FIG. 1C, the interconnector 4 may extend to the lower end of the cell 1. At the lower end portion of the cell 1, the interconnector 4 and the solid electrolyte layer 6 are exposed on the surface. Note that, as illustrated in FIG. 1A, on the surface of the pair of the circular arc-shaped side surfaces m of the cell 1, the solid electrolyte layer 6 is exposed. The interconnector 4 need not extend to the lower end of the cell 1.

Hereinafter, each of constituent members constituting the cell 1 is described.

The support substrate 2 includes gas-flow passages 2a, inside which gas flows. The example of the support substrate 2 illustrated in FIG. 1A includes six gas-flow passages 2a. The support substrate 2 has gas permeability and allows a fuel gas flowing through the gas-flow passages 2a to permeate to the fuel electrode 5. The support substrate 2 may be electrically conductive. The support substrate 2 having electrical conductivity collects electricity generated in the element portion 3 to the interconnector 4.

The material of the support substrate 2 includes, for example, an iron group metal component and an inorganic oxide. For example, the iron group metal component may be Ni (nickel) and/or NiO. The inorganic oxide may be, for example, a specific rare earth element oxide. The rare earth element oxide may contain one or more rare earth elements, for example, selected from the group consisting of Sc, Y, La, Nd, Sm, Gd, Dy, and Yb. The details of the support substrate 2 will be described later.

The fuel electrode 5 may be made of a porous electrically conductive ceramic. As the material of the fuel electrode 5, for example, ceramics containing ZrO₂ in which a calcium oxide, a magnesium oxide, or a rare earth element oxide is contained as a solid solution, and Ni and/or NiO may be used. This rare earth element oxide may contain a plurality of rare earth elements, for example, selected from the group consisting of Sc, Y, La, Nd, Sm, Gd, Dy, and Yb. Hereinafter, ZrO₂ in which a calcium oxide, a magnesium oxide, or a rare earth element oxide is in solid solution may be referred to as stabilized zirconia. Stabilized zirconia may include partially stabilized zirconia. The fuel electrode 5 is an example of the first electrode.

The fuel electrode 5 may contain, for example, cerium oxide (CeO₂) in which a rare earth element such as lanthanum (La), gadolinium (Gd), or samarium (Sm) is contained as a solid solution. The fuel electrode 5 may contain a perovskite-type compound such as BaMO₃ or SrMO₃ (where M is Zr and/or Ce) in which a rare earth element is contained as a solid solution.

The content of ZrO₂, CeO₂, BaMO₃, SrMO₃, or the like in which the rare earth element oxide is contained as a solid solution in the fuel electrode 5 may be in a range from 35 vol % to 65 vol %. The content of Ni and/or NiO may be from 65 vol % to 35 vol %. The porosity of the fuel electrode 5 may be 15% or more, particularly in a range from 20% to 40%. The thickness of the fuel electrode 5 may be from 1 μm to 30 μm.

The solid electrolyte layer 6 is an electrolyte and delivers ions between the fuel electrode 5 and the air electrode 8. At the same time, the solid electrolyte layer 6 has gas blocking properties, and makes a leakage of the fuel gas and the oxygen-containing gas less likely to occur.

The solid electrolyte layer 6 contains Zr. The material of the solid electrolyte layer 6 may be, for example, ZrO₂ in which from 3 mole % to 15 mole % of a rare earth element oxide, calcium oxide, or magnesium oxide is contained as a solid solution. The rare earth element oxide may contain one or more rare earth elements, for example, selected from the group consisting of Sc, Y, La, Nd, Sm, Gd, Dy, and Yb. The material of the solid electrolyte layer 6 may be, for example, stabilized zirconia containing Sc, Y, Yb, or the like. The solid electrolyte layer 6 may contain, for example, a perovskite-type compound such as BaZrO₃ or SrZrO₃ in which a rare earth element such as Sc, Y, La, Nd, Sm, Gd, Dy, or Yb is contained as a solid solution.

The air electrode 8 has gas permeability. The air electrode 8 is an example of the second electrode. The open porosity of the air electrode 8 may be, for example, in the range of from 20% to 50%, particularly, in the range of from 30% to 50%.

The material of the air electrode 8 is not particularly limited, as long as the material is one generally used for the air electrode. The material of the air electrode 8 may be, for example, an electrically conductive ceramic such as a so-called ABO₃ type perovskite oxide.

The material of the air electrode 8 may be, for example, a composite oxide in which strontium (Sr) and lanthanum (La) coexist at the A site. Examples of such a composite oxide include LaₓSr₁₋ₓCo_{y}Fe_{1-y}O₃, LaₓSr₁₋ₓMnO₃, LaₓSr₁₋ₓFeO₃, and LaₓSr₁₋ₓCoO₃. Here, x is 0<x<1, and y is 0<y<1.

When the element portion 3 includes the intermediate layer 7, the intermediate layer 7 functions as a diffusion suppression layer. When an element such as strontium (Sr) contained in the air electrode 8 diffuses into the solid electrolyte layer 6, a resistance layer such as, for example, SrZrO₃ is formed in the solid electrolyte layer 6. The intermediate layer 7 makes it difficult to diffuse Sr, thereby making it difficult to form SrZrO₃ and other oxides having electrical insulation properties.

The material of the intermediate layer 7 is not particularly limited as long as the material is not likely to cause the diffusion of elements between the air electrode 8 and the solid electrolyte layer 6 in general. The material of the intermediate layer 7 may contain, for example, cerium oxide (CeO₂) in which rare earth elements other than cerium (Ce) are in solid solution. As such rare earth elements, for example, gadolinium (Gd), samarium (Sm), or the like may be used.

The interconnector 4 is dense, and makes, less likely to occur, the leakage of the fuel gas flowing through the gas-flow passages 2a located inside the support substrate 2, and of the oxygen-containing gas flowing outside the support substrate 2. The interconnector 4 may have a relative density of 93% or more, particularly 95% or more.

As the material of the interconnector 4, a lanthanum chromite-based perovskite oxide (LaCrO₃-based oxide), a lanthanum strontium titanium-based perovskite oxide (LaSrTiO₃-based oxide), or the like may be used. These materials have electrical conductivity, and are unlikely to be reduced and also unlikely to be oxidized even when brought into contact with a fuel gas such as a hydrogen-containing gas and an oxygen-containing gas such as air. A metal or an alloy may be used as the material of the interconnector 4.

### Configuration of Electrochemical Cell Device

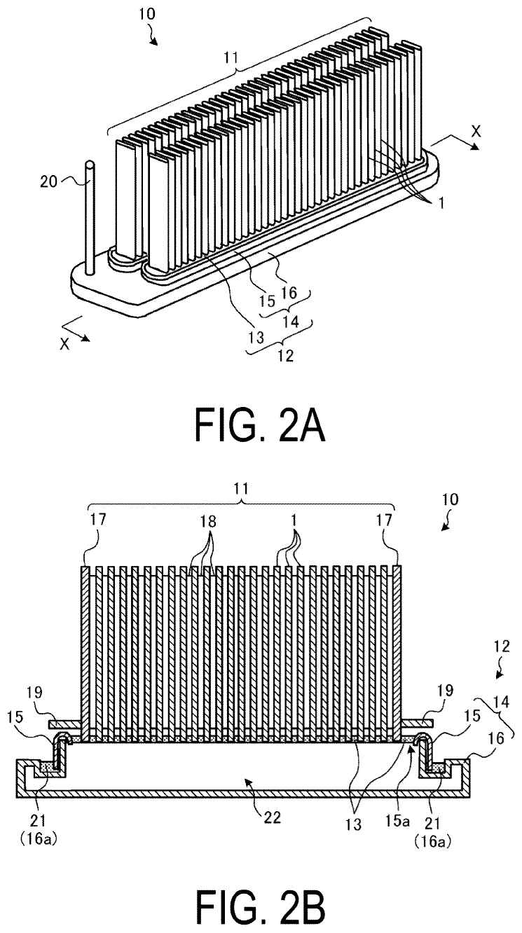

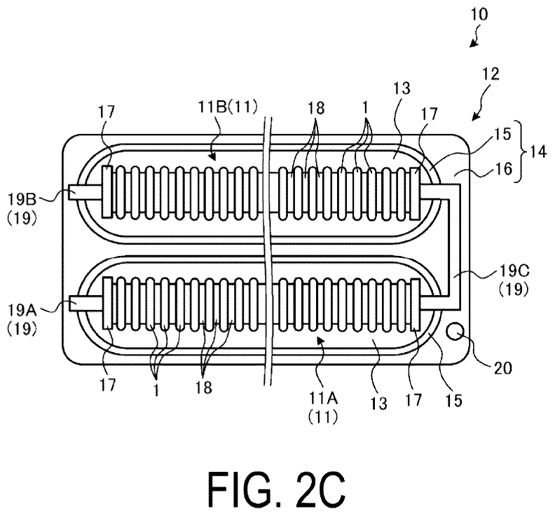

An electrochemical cell device according to the present embodiment using the electrochemical cell described above will now be described with reference to FIGS. 2A to 2C. FIG. 2A is a perspective view illustrating an example of an electrochemical cell device according to the first embodiment. FIG. 2B is a cross-sectional view taken along a line X-X illustrated in FIG. 2A. FIG. 2C is a top view illustrating an example of the electrochemical cell device according to the first embodiment.

As illustrated in FIG. 2A, the cell stack device 10 includes a cell stack 11 including a plurality of the cells 1 arrayed (stacked) in the thickness direction T of each cell 1, and a fixing member 12 (see FIG. 1A).

The fixing member 12 includes a fixing material 13 and a support member 14. The support member 14 supports the cells 1. The fixing material 13 fixes the cells 1 to the support member 14. The support member 14 includes a support body 15 and a gas tank 16. The support body 15 and the gas tank 16, constituting the support member 14, are made of a metal and electrically conductive, for example.

As illustrated in FIG. 2B, the support body 15 includes an insertion hole 15a into which the lower end portions of the plurality of cells 1 are inserted. The lower end portions of the plurality of cells 1 and the inner wall of the insertion hole 15a are bonded with the fixing material 13.

The gas tank 16 includes an opening portion through which a reactive gas is supplied to the plurality of cells 1 via the insertion hole 15a, and a recessed groove 16a located on the periphery of the opening portion. The outer peripheral end portion of the support body 15 is bonded to the gas tank 16 by a bonding material 21 with which the recessed groove 16a of the gas tank 16 is filled.

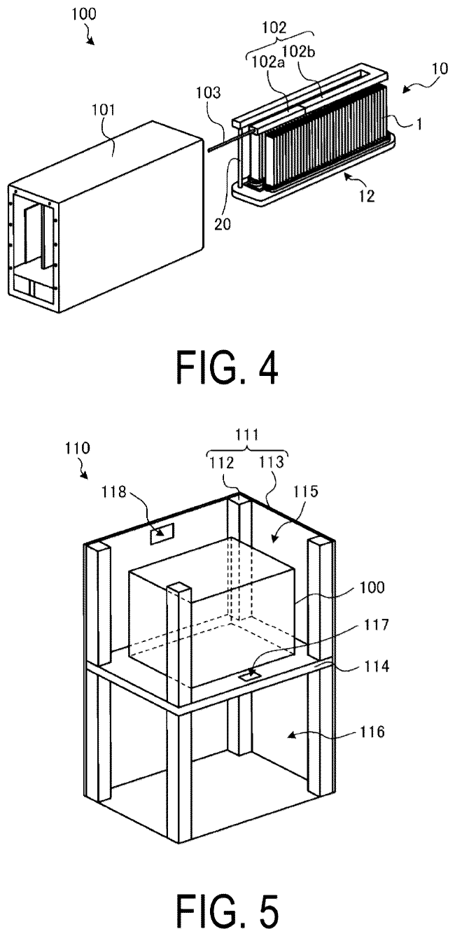

In the example illustrated in FIG. 2A, the fuel gas is stored in an internal space 22 formed by the support body 15 and the gas tank 16, constituting the support member 14. The gas tank 16 includes a gas circulation pipe 20 connected thereto. The fuel gas is supplied to the gas tank 16 through the gas circulation pipe 20 and is supplied from the gas tank 16 to the gas-flow passages 2a (see FIG. 1A) inside the cells 1. The fuel gas to be supplied to the gas tank 16 is produced in a reformer 102 (see FIG. 4) which will be described later.

A hydrogen-rich fuel gas can be produced, for example, by steam-reforming a raw fuel. When the fuel gas is produced by steam-reforming, the fuel gas contains steam.

In the example illustrated in FIG. 2A, the cell stack device 10 includes two rows of the cell stacks 11, the two support bodies 15, and the gas tank 16. Each of the two rows of the cell stacks 11 includes the plurality of cells 1. Each of the cell stacks 11 is fixed to a corresponding one of the support bodies 15. An upper surface of the gas tank 16 includes two through holes. Each of the support bodies 15 is disposed in a corresponding one of the through holes. The internal space 22 is constituted by a single gas tank 16 and two support bodies 15. Although the cell stack device 10 including the two rows of cell stacks 11 is illustrated in FIG. 2A, the cell stack device may include one row of cell stacks 11 or three or more rows of cell stacks 11.

The insertion hole 15a has, for example, an oval shape in a top surface view. The length of the insertion hole 15a in an arrangement direction of the cells 1, that is, the thickness direction T, may be longer than the distance between two end current collection members 17 located at both ends of the cell stack 11, for example. The width of the insertion hole 15a may be, for example, greater than the length of the cell 1 in the width direction W (see FIG. 1A).

As illustrated in FIG. 2B, the joined portions between the inner wall of the insertion hole 15a and the lower end portions of the cells 1 are filled with the fixing material 13, which is solidified. As a result, the inner wall of the insertion hole 15a and the lower end portions of the plurality of cells 1 are bonded and fixed, and the lower end portions of the cells 1 are bonded and fixed to each other. The gas-flow passages 2a of each of the cells 1 communicate, at the lower end portion, with the internal space 22 of the support member 14.

The fixing material 13 and the bonding material 21 may be one having a low electrical conductivity, such as glass. As the specific materials of the fixing material 13 and the bonding material 21, amorphous glass or the like may be used, and especially, crystallized glass or the like may be used.

As the crystallized glass, for example, any one selected from the group consisting of SiO₂—CaO-based, MgO—B₂O₃-based, La₂O₃—B₂O₃—MgO-based, La₂O₃—B₂O₃—ZnO-based, and SiO₂—CaO—ZnO-based materials may be used, or, in particular, an SiO₂—MgO-based material may be used.

As illustrated in FIG. 2B, a conductive member 18 is interposed between cells 1 adjacent to each other among the plurality of cells 1. Each of the conductive members 18 electrically connects in series the fuel electrode 5 of one of the adjacent cells 1 with the air electrode 8 of the other one of the adjacent cells 1. More specifically, the electrically conductive member 18 connects the interconnector 4 electrically connected to the fuel electrode 5 of the one of the adjacent ones of the cells 1 and the air electrode 8 of the other one of the adjacent ones of the cells 1. Note that, when the interconnector 4 is made of a metal or an alloy, the interconnector 4 and the electrically conductive member 18 may be integrated with each other, or the electrically conductive member 18 may also serve as the interconnector 4.

As illustrated in FIG. 2B, the end current collection members 17 are electrically connected to the cells 1 located at the outermost sides in the arrangement direction of the plurality of cells 1. The end current collection members 17 are each connected to an electrically conductive portion 19 protruding outward from the cell stack 11. The electrically conductive portion 19 collects electricity generated by the cells 1 and conducts the electricity to the outside. Note that in FIG. 2A, the end current collection members 17 are not illustrated.

As illustrated in FIG. 2C, in the cell stack device 10, two cell stacks 11A and 11B are connected in series and function as one battery. Therefore, the conductive portion 19 of the cell stack device 10 is divided into a positive electrode terminal 19A, a negative electrode terminal 19B, and a connection terminal 19C.

The positive electrode terminal 19A functions as a positive electrode when the electrical power generated by the cell stack 11 is output to the outside. The positive electrode terminal 19A is electrically connected to the end current collection member 17 on a positive electrode side in the cell stack 11A. The negative electrode terminal 19B functions as a negative electrode when the electrical power generated by the cell stack 11 is output to the outside. The negative electrode terminal 19B is electrically connected to the end current collection member 17 on a negative electrode side in the cell stack 11B.

The connection terminal 19C electrically connects the end current collection member 17 on the negative electrode side in the cell stack 11A and the end current collection member 17 on the positive electrode side in the cell stack 11B.

### Details of Electrochemical Cell

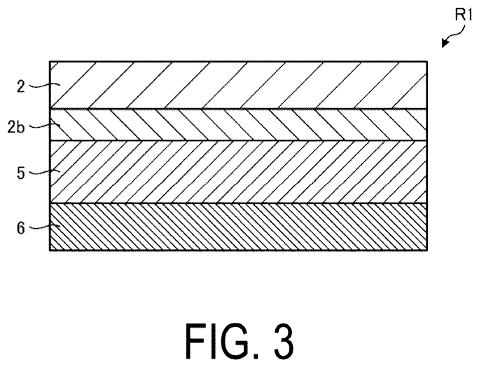

Subsequently, details of the electrochemical cell including the support substrate 2 according to the first embodiment are described with reference to FIG. 3. FIG. 3 is an enlarged cross-sectional view of the region R1 indicated in FIG. 1A.

As illustrated in FIG. 3, the cell 1 includes the solid electrolyte layer 6, the fuel electrode 5 as the first electrode, the support substrate 2 as the first electrically conductive member, and a second electrically conductive member 2b. For example, there is a case where the performance of the element portion 3 is improved by using an ion conductive material containing the first element for the first electrode, and a material containing the second element different from the first element is used for the first electrically conductive member. As a result, coefficients of thermal expansion of the first electrode and the first electrically conductive member can be adjusted, and the first electrode can be less likely to peel off from the first electrically conductive member.

The solid electrolyte layer 6 contains the first material containing the first element. The first element may be in solid solution in the first element. The first element is one or more elements selected from the group consisting of Mg, Ca, and rare earth elements. The rare earth element may contain one or more elements, for example, selected from the group consisting of Sc, Y, La, Nd, Sm, Gd, Dy, and Yb. The first material may contain an oxide-based solid electrolyte material in which an oxide of the first element is in a solid solution. The first material may contain, for example, stabilized zirconia containing Sc, Y, Yb, or the like.

The fuel electrode 5 contains the first material having ion conductivity and the second material having electron conductivity. The second material may be, for example, Ni or NiO.

The support substrate 2 contains the second element and the second material. The second element is one or more elements selected from the group consisting of Mg, Ca, Ti, Al, Si, and rare earth elements, and is different from the first element. The support substrate 2 may contain an oxide of the second element. The support substrate 2 may contain, for example, Sc₂O₃, Y₂O₃, or Yb₂O₃.

The second electrically conductive member 2b is located between the fuel electrode 5 as the first electrode and the support substrate 2 as the first electrically conductive member. The second electrically conductive member 2b contains the first element, the second element, and the second material. The second electrically conductive member 2b may contain an oxide of the first element and an oxide of the second element. The second electrically conductive member 2b may contain the first material.

Content ratios of the first element, the second element, the first material, and the second material may be confirmed by, for example, elemental analysis using EPMA. Specifically, a content ratio of each of the first element, the second element, the first material, and the second material per unit area can be calculated by mirror-polishing the cross section of the element portion 3 in the layering direction and performing semi-quantitative analysis on each of the first element, the second element, the first material, and the second material in a predetermined surface area. The content ratio of the first element may be evaluated, for example, as a ratio of the first element to the total of the first element, the second element, and metal elements constituting the first material.

Since the second electrically conductive member 2b containing the first element contained in the fuel electrode 5 and the second element contained in the support substrate 2 is located between the fuel electrode 5 and the support substrate 2, a difference in thermal expansion between the fuel electrode 5 and the support substrate 2 can be reduced. Thus, with the cell 1 according to the present embodiment, durability can be improved.

The content ratio of the first element contained in the fuel electrode 5 may decrease toward the support substrate 2 in the cross section of the element portion 3 in the layering direction. A content ratio of the first element in the fuel electrode 5 may be distributed so as to become smaller toward a boundary between the fuel electrode 5 and the second electrically conductive member 2b. As a result, the durability of the cell 1 further improves.

The fuel electrode 5, the second electrically conductive member 2b, and the support substrate 2 may each have a site in which the content ratio of the first element has a local maximum value and/or a local minimum value in a cross section of the element portion 3 in the layering direction. The local maximum value is a locally maximum value, and the local minimum value is a locally minimum value.

The boundary between the second electrically conductive member 2b and the fuel electrode 5 is, for example, a site closest to the solid electrolyte layer 6 among sites at which the content ratio of the first element has the local minimum value. The content ratio of the first element included in the boundary between the second electrically conductive member 2b and the fuel electrode 5 may be, for example, ⅓ or less of the content ratio of the first element near the solid electrolyte layer 6 of the fuel electrode 5.

The boundary between the second electrically conductive member 2b and the support substrate 2 is, for example, a site in which a distance from the solid electrolyte layer 6 is larger than a distance to a boundary between the second electrically conductive member 2b and the fuel electrode 5, and the content ratio of the first element is equal to the content ratio of the first element at the boundary between the second electrically conductive member 2b and the fuel electrode 5.

The second electrically conductive member 2b may have a site in which the content ratio of the first element has a local maximum value between the boundary between the second electrically conductive member 2b and the fuel electrode 5 and the boundary between the second electrically conductive member 2b and the support substrate 2.

The second electrically conductive member 2b may contain more first material containing the first element in a site closer to the fuel electrode 5 than in a site away from the fuel electrode 5. As a result, the fuel electrode 5 is less likely to peel off from the support substrate 2. The second electrically conductive member 2b may contain more oxide of the first element in a site closer to the support substrate 2 than in a site away from the support substrate 2. As a result, the fuel electrode 5 is less likely to peel off from the support substrate 2. The second electrically conductive member 2b may contain the first material containing the second element in the site closer to the fuel electrode 5.

The content ratios of the second material in the fuel electrode 5, the support substrate 2, and the second electrically conductive member 2b may be the same or different from each other.

### Module

Descriptions of the module according to the present embodiment using the above-described electrochemical cell device will now be given with reference to FIG. 4. FIG. 4 is an exterior perspective view illustrating a module according to the first embodiment. FIG. 4 illustrates a state in which the front and rear surfaces, which constitute part of a storage container 101, are removed, and the cell stack device 10 of the fuel cell stored inside is taken out rearward.

As illustrated in FIG. 4, the module 100 includes the storage container 101, and the cell stack device 10 housed in the storage container 101. The reformer 102 is disposed above the cell stack device 10.

The reformer 102 generates a fuel gas by reforming a raw fuel such as natural gas and kerosene and supplies the fuel gas to the cell 1. The raw fuel is supplied to the reformer 102 through a raw fuel supply pipe 103. Note that the reformer 102 may include a vaporizing unit 102a for vaporizing water and a reformer 102b. The reformer 102b includes a reforming catalyst (not illustrated) to reform the raw fuel into a fuel gas. The reformer 102 can perform steam-reforming, which is a highly efficient reformation reaction.

The fuel gas generated by the reformer 102 is supplied to the gas-flow passages 2a of the cell 1 (see FIG. 1A) through the gas circulation pipe 20, the gas tank 16, and the support member 14.

In the module 100 having the configuration mentioned above, the temperature in the module 100 during normal power generation is from about 500 °C to 1000 °C due to combustion of gas and power generation by the cell 1.

As described above, the module 100 is configured by housing the cell stack device 10 having high durability, so that the module 100 having high durability can be obtained.

### Module Housing Device

FIG. 5 is an exploded perspective view illustrating an example of a module housing device according to the first embodiment. A module housing device 110 according to the present embodiment includes an external case 111, the module 100 illustrated in FIG. 4, and an auxiliary device (not illustrated). The auxiliary device operates the module 100. The module 100 and the auxiliary device are housed in the external case 111. Note that part of the configuration is not illustrated in FIG. 5.

The external case 111 of the module housing device 110 illustrated in FIG. 5 includes a support 112 and an external plate 113. A dividing plate 114 vertically partitions the interior of the external case 111. The space above the dividing plate 114 in the external case 111 is a module housing chamber 115 for housing the module 100. The space below the dividing plate 114 in the external case 111 is an auxiliary device housing chamber 116 for housing the auxiliary device configured to operate the module 100. Note that, in FIG. 5, the auxiliary device housed in the auxiliary device housing chamber 116 is not illustrated.

The dividing plate 114 includes an air circulation hole 117 for causing air in the auxiliary device housing chamber 116 to flow to the module housing chamber 115 side. The external plate 113 constituting the module housing chamber 115 has an exhaust hole 118 for discharging air inside the module housing chamber 115.

In the module housing device 110, the module housing device 110 having high durability can be obtained by providing the module 100 having high durability in the module housing chamber 115 as described above.

Note that, in the embodiment described above, the case in which the support substrate having the hollow flat plate shape is used has been exemplified, but the embodiment can also be applied to a cell stack device using a cylindrical support substrate.

### Second Embodiment

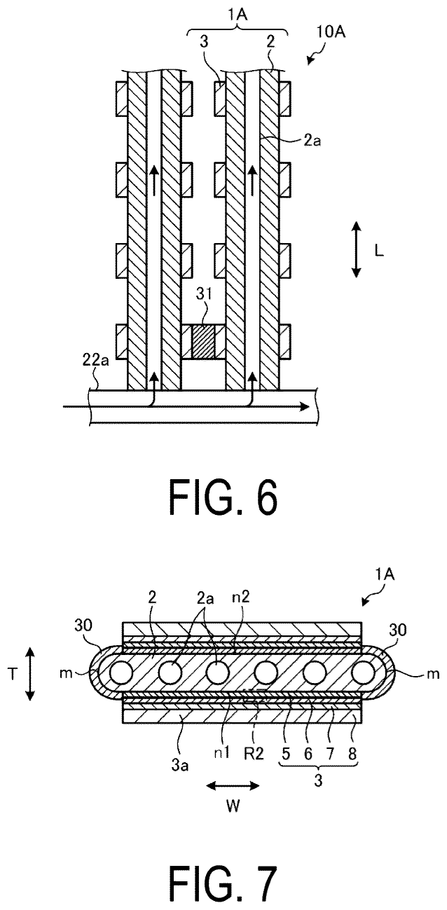

Next, an electrochemical cell and an electrochemical cell device according to a second embodiment will be described with reference to FIGS. 6 to 8.

In the embodiment described above, a so-called “vertically striped type” electrochemical cell device, in which only one element portion including the fuel electrode layer, the solid electrolyte layer, and the air electrode layer is provided on the surface of the support substrate, is exemplified. However, the present disclosure can be applied to a horizontally striped type electrochemical cell device with an array of so-called “horizontally striped type” electrochemical cells, in which a plurality of element portions are provided on the surface of the support substrate at mutually separated locations, and adjacent element portions are electrically connected to each other.

FIG. 6 is a cross-sectional view illustrating an electrochemical cell device according to the second embodiment. FIG. 7 is a horizontal cross-sectional view illustrating an example of an electrochemical cell according to the second embodiment.

As illustrated in FIG. 6, a cell stack device 10A according to the second embodiment includes a plurality of cells 1A extending in the length direction L from a pipe 22a configured to distribute a fuel gas. Each of the cells 1A includes a plurality of the element portions 3 on the support substrate 2. A gas-flow passage 2a, through which a fuel gas from the pipe 22a flows, is provided inside the support substrate 2.

The cells 1A are electrically connected to each other via connecting members 31. Each of the connecting members 31 is located between the element portions 3 each included in a corresponding one of the cells 1A and electrically connects adjacent ones of the cells 1A to each other. Specifically, the connecting member 31 electrically connects the air electrode 8 of the element portion 3 of one of the adjacent ones of the cells 1A to the fuel electrode 5 of the element portion 3 of the other one of the adjacent ones of the cells 1A.

As illustrated in FIG. 7, the cell 1A includes a support substrate 2, a pair of element portions 3, and a sealing portion 30. The support substrate 2 has a pillar shape having a first surface n1 and a second surface n2 which are a pair of flat surfaces facing each other, and a pair of circular arc-shaped side surfaces m that connect the first surface n1 and the second surface n2.

The pair of element portions 3 are located on the first surface n1 and the second surface n2 of the support substrate 2 so as to face each other. The sealing portion 30 is located to cover the side surfaces m of the support substrate 2.

The cell 1A may have a shape that is symmetric with respect to a plane that passes through a center in the thickness direction T and is parallel to the first surface n1 and the second surface n2 of the support substrate 2. The element portion 3 includes the fuel electrode 5, the solid electrolyte layer 6, and the air electrode 8. The element portion 3 may include the intermediate layer 7 between the solid electrolyte layer 6 and the air electrode 8.

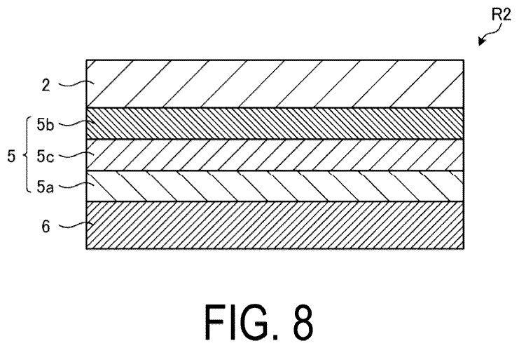

FIG. 8 is an enlarged cross-sectional view of a region R2 indicated in FIG. 7. As illustrated in FIG. 8, the cell 1A includes the solid electrolyte layer 6, the fuel electrode 5, and the support substrate 2 with an insulating property.

The solid electrolyte layer 6 contains the first material in which the first element is in a solid solution. The first element is one or more elements selected from the group consisting of Mg, Ca, and rare earth elements. The first material may contain, for example, stabilized zirconia containing Sc, Y, Yb, or the like.

The fuel electrode 5 includes a fuel electrode functional layer 5a as the first electrode, a fuel electrode current collector layer 5b as the first electrically conductive member, and a second electrically conductive member 5c. The fuel electrode functional layer 5a contains the first material having ion conductivity and the second material having electron conductivity.

The fuel electrode current collector layer 5b is the first electrically conductive member and contains the second element and the second material. The second element is one or more elements selected from the group consisting of Mg, Ca, Ti, Al, Si, and rare earth elements, and is different from the first element. The fuel electrode current collector layer 5b may contain, for example, stabilized zirconia containing Sc, Y, Yb, or the like. The support substrate 2 with an insulating property may or need not contain, for example, stabilized zirconia containing Sc, Y, Yb, or the like.

The second electrically conductive member 5c is located between the fuel electrode functional layer 5a as the first electrode, and the fuel electrode current collector layer 5b as the first electrically conductive member. The second electrically conductive member 5c contains the first element, the second element, and the second material.

Since the second electrically conductive member 5c containing the first element contained in the fuel electrode functional layer 5a and the second element contained in the fuel electrode current collector layer 5b is located between the fuel electrode functional layer 5a and the fuel electrode current collector layer 5b as described above, the difference in thermal expansion between the fuel electrode functional layer 5a and the fuel electrode current collector layer 5b can be reduced. Thus, with the cell 1A according to the present embodiment, durability can be improved.

### Third Embodiment

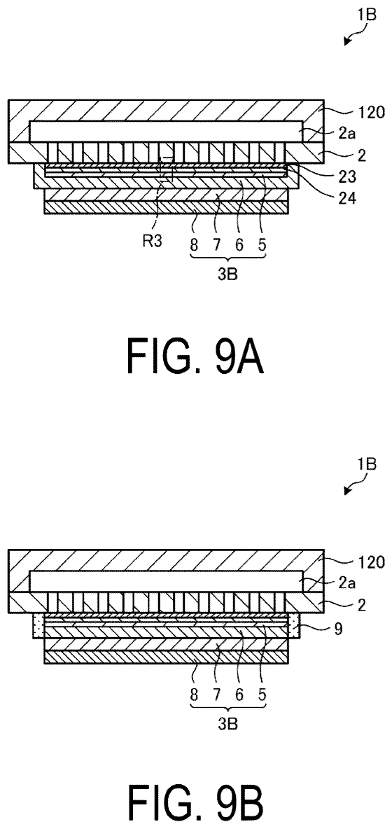

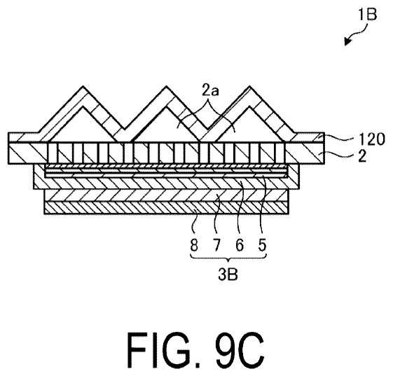

FIG. 9A is a horizontal cross-sectional view illustrating an example of the electrochemical cell according to a third embodiment. FIGS. 9B and 9C are horizontal cross-sectional views each illustrating another example of the electrochemical cell according to the third embodiment.

As illustrated in FIGS. 9A to 9C, a cell 1B includes an element portion 3B in which the fuel electrode 5, the solid electrolyte layer 6, and the air electrode 8 are included, and the support substrate 2. The element portion 3B may include the intermediate layer 7 between the solid electrolyte layer 6 and the air electrode 8. The support substrate 2 has through holes or fine holes at a site in contact with the element portion 3B, and includes a member 120 located outside the gas-flow passage 2a. The support substrate 2 allows gas to flow between the gas-flow passage 2a and the element portion 3B. The support substrate 2 may be made of, for example, one or more metal plates. A material of the metal plate may contain chromium. The metal plate may include an electrically conductive coating layer. The support substrate 2 electrically connects adjacent ones of the cells 1B to each other. The element portion 3B is bonded to the support substrate 2 by bonding materials 23 and 24.

In the example illustrated in FIG. 9A, the side surface of the fuel electrode 5 is coated with the solid electrolyte layer 6 to hermetically seal the gas-flow passage 2a through which the fuel gas flows. As illustrated in FIG. 9B, the side surface of the fuel electrode 5 may be covered and sealed with a dense sealing material 9 containing glass or ceramic. The sealing material 9 coating the side surface of the fuel electrode 5 may have electrical insulation properties.

The gas-flow passage 2a of the support substrate 2 may be made of the member 120 having unevenness as illustrated in FIG. 9C.

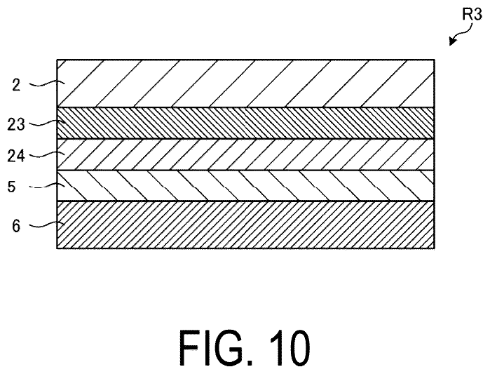

FIG. 10 is an enlarged cross-sectional view of a region R3 illustrated in FIG. 9A. As illustrated in FIG. 10, the cell 1B includes the solid electrolyte layer 6, the fuel electrode 5 as the first electrode, the bonding material 23 as the first electrically conductive member and the bonding material 24 as the second electrically conductive member. Note that FIG. 10 can also be applied to the examples in FIGS. 9B and 9C.

The solid electrolyte layer 6 contains the first material in which the first element is in a solid solution. The first element is one or more elements selected from the group consisting of Mg, Ca, and rare earth elements.

The fuel electrode 5 contains the first material having ion conductivity and the second material having electron conductivity.

The bonding material 23 contains the second element and the second material. The second element is one or more elements selected from the group consisting of Mg, Ca, Ti, Al, Si, and rare earth elements, and is different from the first element. The bonding material 23 may contain an oxide of the second element. The bonding material 23 may contain, for example, TiO₂, Al₂O₃, or SiO₂.

The bonding material 24 as the second electrically conductive member is located between the fuel electrode 5 as the first electrode and the bonding material 23 as the first electrically conductive member. The bonding material 24 contains the first element, the second element, and the second material.

As described above, since the bonding material 24 containing the first element contained in the fuel electrode 5 and the first material containing the second element contained in the bonding material 23 is located between the fuel electrode 5 and the bonding material 23, the difference in thermal expansion between the fuel electrode 5 and the bonding material 23 can be reduced. Thus, with the cell 1B according to the present embodiment, durability can be improved.

### Other Embodiments

An electrochemical cell device according to other embodiments will be described.

In the above embodiments, a fuel cell, a fuel cell stack device, a fuel cell module, and a fuel cell device are illustrated as examples of the “electrochemical cell”, the “electrochemical cell device”, the “module”, and the “module housing device”; however, other examples include an electrolytic cell, an electrolytic cell stack device, an electrolytic module, and an electrolytic device, respectively. The electrolytic cell includes a first electrode layer and a second electrode layer, and decomposes water vapor into hydrogen and oxygen or decomposes carbon dioxide into carbon monoxide and oxygen by supplying electric power. Although an oxide ion conductor or a hydrogen ion conductor is described as an example of the electrolyte material of the electrochemical cell in the above embodiment, the electrolyte material may be a hydroxide ion conductor. Such an electrolytic cell, an electrolytic cell stack device, an electrolytic module, and an electrolytic device can have an improved durability.

While the present disclosure has been described in detail, the present disclosure is not limited to the aforementioned embodiments, and various changes, improvements, and the like can be made without departing from the gist of the present disclosure.
In one embodiment, (1) an electrochemical cell includes a first electrode containing a first material having ion conductivity and in which a first element is in a solid solution and a second material having electron conductivity, a first electrically conductive member containing a second element different from the first element and the second material, and a second electrically conductive member located between the first electrode and the first electrically conductive member and containing the first element, the second element, and the second material, in which the first element is one or more elements selected from the group consisting of Mg, Ca, and rare earth elements, and the second element is one or more elements selected from the group consisting of Mg, Ca, Ti, Al, Si, and rare earth elements.
(2) In the electrochemical cell as recited in (1) above, the first electrically conductive member may contain an oxide of the second element.
(3) In the electrochemical cell as recited in (1) or (2), the second electrically conductive member may contain an oxide of the first element and an oxide of the second element.
(4) In the electrochemical cell as recited in any one of (1) to (3), the second electrically conductive member may contain the first material.
(5) In the electrochemical cell as recited in any one of (1) to (4), the second electrically conductive member may have a site in which a content ratio of the first element has a local maximum value between a boundary between the first electrode and the second electrically conductive member and a boundary between the first electrically conductive member and the second electrically conductive member.
In one embodiment, (6) an electrochemical cell device includes a cell stack including the electrochemical cell as recited in any one of (1) to (5) above.
In one embodiment, (7) a module includes the electrochemical cell device as recited in (6) and a storage container housing the electrochemical cell device.
In one embodiment, (8) a module housing device includes the module as recited in (7), an auxiliary device for operating the module, and an external case housing the module and the auxiliary device.
In one embodiment, (9) an electrochemical cell includes a first electrode containing a first material containing a first element and having ion conductivity, and a second material having electron conductivity, a first electrically conductive member containing a second element different from the first element, and the second material, and a second electrically conductive member located between the first electrode and the first electrically conductive member and containing the first element, the second element, and the second material, in which the first element is one or more elements selected from the group consisting of Mg, Ca, and rare earth elements, and the second element is one or more elements selected from the group consisting of Mg, Ca, Ti, Al, Si, and rare earth elements.

Note that the embodiments disclosed herein are exemplary in all respects and not restrictive. The aforementioned embodiments can be embodied in a variety of forms. The aforementioned embodiments may be omitted, replaced, or changed in various forms without departing from the scope of the appended claims and the purpose thereof.

### REFERENCE SIGNS

1 Cell
2 Support substrate
2b Second electrically conductive member
5 Fuel electrode
6 Solid electrolyte layer
10 Cell stack device
11 Cell stack
12 Fixing member
13 Fixing material
14 Support member
15 Support body
16 Gas tank
17 End current collection member
18 Electrically conductive member
100 Module
110 Module housing device

1. An electrochemical cell comprising:
a first electrode containing
a first material having ion conductivity and in which a first element is in a solid solution, and
a second material having electron conductivity;
a first electrically conductive member containing
a second element different from the first element, and
the second material; and
a second electrically conductive member located between the first electrode and the first electrically conductive member and containing the first element, the second element, and the second material, wherein
the first element is one or more elements selected from the group consisting of Mg, Ca, and rare earth elements, and
the second element is one or more elements selected from the group consisting of Mg, Ca, Ti, Al, Si, and rare earth elements.

2. The electrochemical cell according to claim 1, wherein
the first electrically conductive member contains an oxide of the second element.

3. The electrochemical cell according to claim 1, wherein
the second electrically conductive member contains an oxide of the first element and an oxide of the second element.

4. The electrochemical cell according to claim 1, wherein
the second electrically conductive member contains the first material.

5. The electrochemical cell according to claim 1, wherein
the second electrically conductive member has a site in which a content ratio of the first element has a local maximum value between a boundary between the first electrode and the second electrically conductive member and a boundary between the first electrically conductive member and the second electrically conductive member.

6. An electrochemical cell device comprising:
a cell stack comprising the electrochemical cell according to claim 1.

7. A module comprising:
the electrochemical cell device according to claim 6; and
a storage container housing the electrochemical cell device.

8. A module housing device comprising:
the module according to claim 7;
an auxiliary device configured to operate the module; and
an external case housing the module and the auxiliary device.

9. An electrochemical cell comprising:
a first electrode containing
a first material containing a first element and having ion conductivity, and
a second material having electron conductivity;
a first electrically conductive member containing
a second element different from the first element, and
the second material; and
a second electrically conductive member located between the first electrode and the first electrically conductive member and containing the first element, the second element, and the second material, wherein
the first element is one or more elements selected from the group consisting of Mg, Ca, and rare earth elements, and
the second element is one or more elements selected from the group consisting of Mg, Ca, Ti, Al, Si, and rare earth elements.
